(19) United States
(12) Patent Application Publication
(10) Pub. No.: US 2020/0217240 A1
(43) Pub. Date: Jul. 9, 2020

(54) Supercharger Intercooler With Reversion Control

(71) Applicant: James E. Bell, Upland, CA (US)

(72) Inventor: James E. Bell, Upland, CA (US)

(21) Appl. No.: 16/238,851

(22) Filed: Jan. 3, 2019

(51) Int. Cl. F02B 29/04; F02B 33/36

(52) U.S. Cl. CPC F02B 29/0412; F02B 29/0443; F02B 29/0475; F02B 33/36; F02B 29/0462

(57) ABSTRACT

A supercharger intercooler includes three sequential Anti-Reversion Plenums (ARPs) separated by heat exchangers, in right and left air paths between the supercharger and intake ports. The intercooler resides above and beside the supercharger and has paths for each bank of a V8 engine. An air flow from the supercharger is up and into a first ARP, is split into right and left flows into right and left first heat exchangers, passes into second ARPs and turns down, flows though right and left second heat exchangers into third ARPs and then into the engine. Reversion pulses from the engine are reduced by each ARP, increasing air flow into the engine, and reducing pulsations in the air flow, thereby increasing power, improving fuel economy, throttle response, driveability, and reducing emissions.

### BACKGROUND OF THE INVENTION

The present invention relates to cooling air compressed by a supercharger and in particular to an intercooler structure including anti-reversion plenums controlling reversion.

Supercharging can greatly increase engine power, but even the most efficient supercharger increases the temperature of the air passing through the supercharger. A supercharger producing ten pounds of boost can easily increase temperature by over 100 degrees Fahrenheit. This increase in temperature may lead to detonation and damage or destruction of an engine.

Modern supercharged engines include intercoolers between the supercharger and engine to reduce the temperature of the air entering the engine. Such intercoolers can be a single simple structure residing in an intake manifold which the air passes through or multiple heat exchangers in the air flow. When multiple air to coolant heat exchangers are present, the sequence of coolant through the heat exchangers can affect the effectiveness of the heat exchangers.

An additional issue is reversion in the intake path. Often, the intake valve opens before the exhaust valve closes. If the pressure in the cylinder is greater then in the intake path, a pulse of exhaust gasses enters the intake path and disrupts air flow into the engine. Uncontrolled reversion reduces air flow into the engine reducing power, especially at wide open throttle, creates turbulence in the air flow, creates pulsations in the air flow, caused uneven distribution of air into the engine reducing fuel economy, throttle response and driveability, and increases emissions. Common carbureted engines often include plenum under the carburetors to reduce the effect of reversion. Known intercooler structures fail to address reversion issues.

U.S. Pat. No. 9,664,152 discloses a supercharger intercooler having a single center heat exchanger directly above the supercharger, and an intercooler housing ceiling just above the single center heat exchanger. The spacing of the single center heat exchanger and housing ceiling is limited by hood clearance of target vehicles. The shallow spacing between the single center heat exchanger and housing ceiling requires an air flow out of the single center heat exchanger to sharply turn to the right and left, restricting air flow. The housing further fails to substantially reduce reversion because only single Anti-Reversion Plenums (ARPs) are provided in the paths between the engine and supercharger.

U.S. Pat. No. 9,683,481 discloses a single center multi-path heat exchanger above the supercharger. As with the '152 patent, due to hood clearance issues, very little space in provided between the single center heat exchanger resulting in a restrictive air flow, which is further restricted by the multi-pass air flow through the single center multi-path heat exchanger. The flow passes through the same heat exchanger multiple times before entering the engine, with no means to tailor the heat exchanger characteristics for each pass through the single heat exchanger. Further, the design disclosed in the '481 patent fails to provide significant anti-reversion.

### BRIEF SUMMARY OF THE INVENTION

The present invention addresses the above and other needs by providing a supercharger intercooler which includes three sequential Anti-Reversion Plenums (ARPs) separated by heat exchangers, in right and left air paths between the supercharger and intake ports. The intercooler resides above and beside the supercharger and has paths for each bank of a V8 engine. An air flow from the supercharger is up and into a first ARP, is split into right and left flows into right and left first heat exchangers, passes into second ARPs and turns down, flows though right and left second heat exchangers into third ARPs and then into the engine. Reversion pulses from the engine are reduced by each ARP, increasing air flow into the engine, and reducing pulsations in the air flow, thereby increasing power, improving fuel economy, throttle response, driveability, and reducing emissions.

In accordance with one aspect of the invention, there is provided an intercooler with three sequential ARPs separated by heat exchangers. Each ARP reduces reversion and the three sequential ARPs provide a combined reduction in reversion before the pulses can reach the engine.

In accordance with another aspect of the invention, there is provided an intercooler with a smooth flow path between right and left first heat exchangers above the supercharger and right and left second heat exchangers on sides of the supercharger. The smooth path minimized turbulence to maximize air flow to the engine.

In accordance with yet another aspect of the invention, there is provided an intercooler suitable for use with twin screw superchargers, roots type superchargers, centrifugal superchargers, turbochargers, and both front inlet and rear inlet superchargers.

In accordance with another aspect of the invention, there is provided an intercooler having four air to liquid heat exchangers. The heat exchangers may be plumbed for parallel or sequential liquid flow.

In accordance with still another aspect of the invention, there is provided an intercooler which is separable from a supercharger. An intercooler housing fits over the supercharger and is attached to engine heads. The intercooler may thus be removed without disturbing the supercharger. An upper intercooler housing is removable from a lower intercooler housing to gain access to all four heat exchangers without removing the lower intercooler housing from the engine.

In accordance with another aspect of the invention, there is provided an intercooler having a continuous air path. Heat exchangers residing in the air paths fill the air paths.

In accordance with yet another aspect of the invention, there is provided an intercooler having four individual heat exchangers providing an ability to adjust air flow, boost, and temperatures. The sizes, fin densities, and coolant flow through each heat exchanger may be tailored for each application. For example, the fin density and/or size may be selected to optimize cooling or pressure drop across each heat exchanger depending on whether the engine banks are hot or cold, lean or rich. Balancing or compensating for each engine bank variables control is provided over the universally recognized variables (temp and pressure/boost) which create harmful engine detonation and therefore limit the ability to use higher boost to increase horse power levels. Boost creates both higher air temps (about 10 degrees per pound of boost) and increases cylinder pressure. By balancing temperatures and air flow for boost or lean or rich conditions, boost may be increased to each engine bank, detonation may be controlled, and horsepower increased. Air-fuel ratio sensors may be applied to each of the cylinders to collect data to adjust the intercooler.

In accordance with still another aspect of the invention, there is provided an intercooler having adjustable coolant flows to four individual heat exchangers. The coolant flow to each heat exchanger may be adjusted and directed (either in parallel or serial flows) to tune the effect of each heat exchanger in flows to the right and left engine banks.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is front and right side quartering view of a supercharger and intercooler assembly according to the present invention.

FIG. 2 is bottom, rear, right side quartering view of the supercharger and intercooler assembly according to the present invention.

FIG. 3A is a right side view of the supercharger and intercooler assembly according to the present invention.

FIG. 3B is a left side view of the supercharger and intercooler assembly according to the present invention.

FIG. 3C is a top view of the supercharger and intercooler assembly according to the present invention.

FIG. 3D is a bottom view of the supercharger and intercooler assembly according to the present invention.

FIG. 4A is a front view of the supercharger and intercooler assembly according to the present invention.

FIG. 4B is a rear view of the supercharger and intercooler assembly according to the present invention.

FIG. 5 is a cross-sectional view of the supercharger and intercooler assembly according to the present invention taken along line 5-5 of FIG. 3B.

FIG. 6 is a cross-sectional view of a supercharger and intercooler assembly according to the present invention taken along line 5-5 of FIG. 3B.

FIG. 7 shows first and second heat exchangers of the supercharger and intercooler assembly according to the present invention.

FIG. 8 shows heat exchangers connected in parallel according to the present invention.

FIG. 9 shows heat exchangers connected in series according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

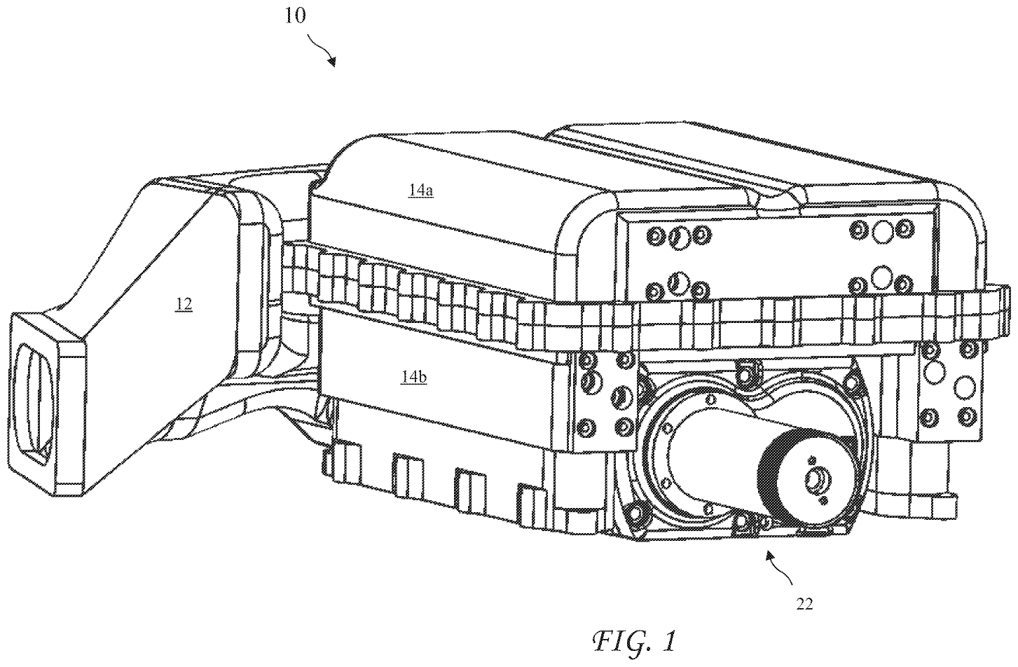

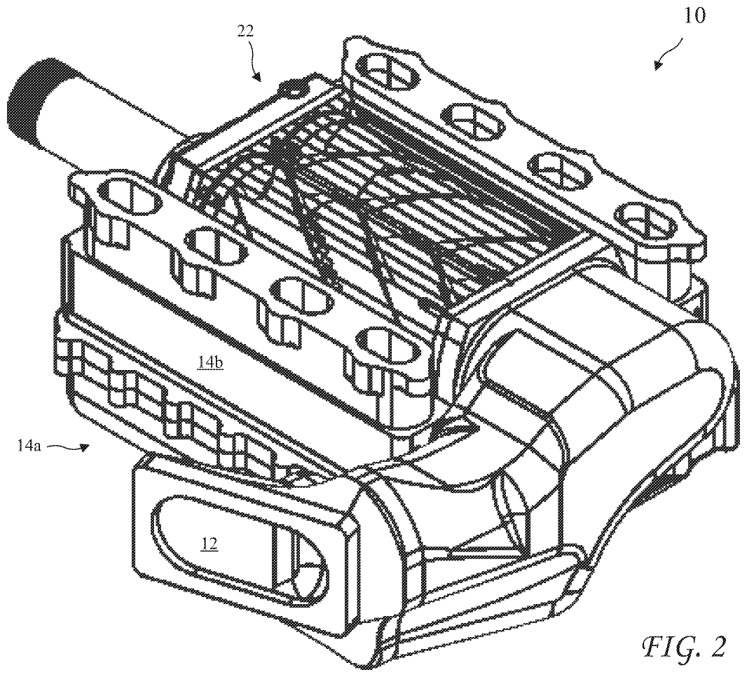

A front and right side quartering view of a supercharger and intercooler assembly 10 according to the present invention is shown in FIG. 1 and a bottom, rear, right side quartering view of the supercharger and intercooler assembly 10 is shown in FIG. 2. The supercharger and intercooler assembly 10 includes an air intake 12, an upper intercooler housing 14a, and a lower intercooler housing 14b. A supercharger 22 resides under the upper intercooler housing 14a and inside the lower intercooler housing 14b.

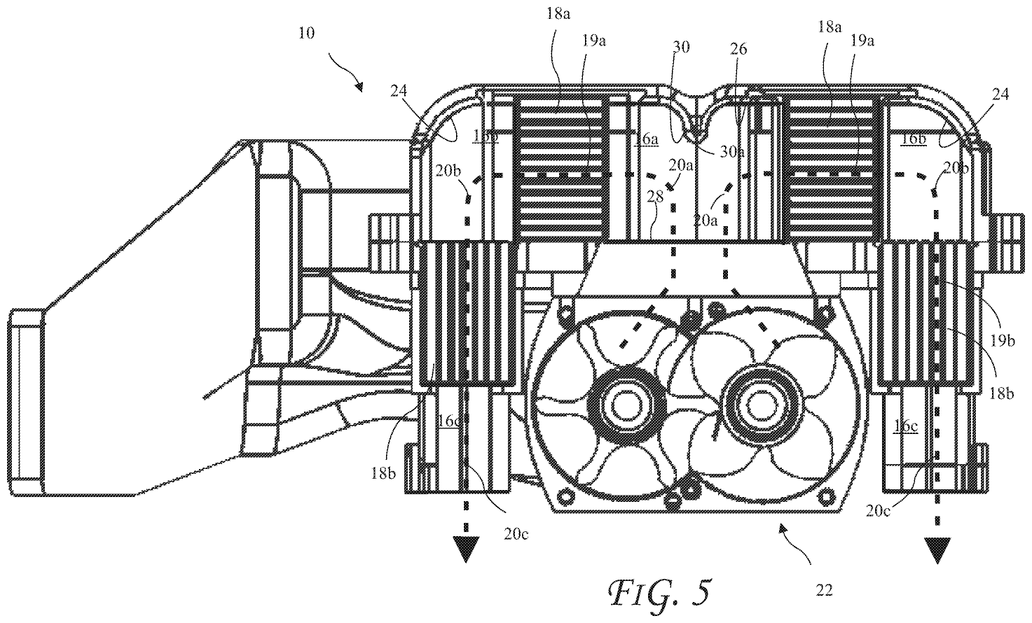

The lower intercooler housing 14b covers and supports the supercharger 22 and the supercharger 22 bolts to the lower intercooler housing 14b. The assembled supercharger 22 and lower intercooler housing 14b are preferably bolted to engine heads, then the upper intercooler housing 14a is bolted on top of the lower intercooler housing 14b. The heat exchangers 18a and 18b (see FIG. 5) are installed into and bolted to the housings 14a and 14b prior to bolting the upper intercooler housing 14a to the lower intercooler housing 14b.

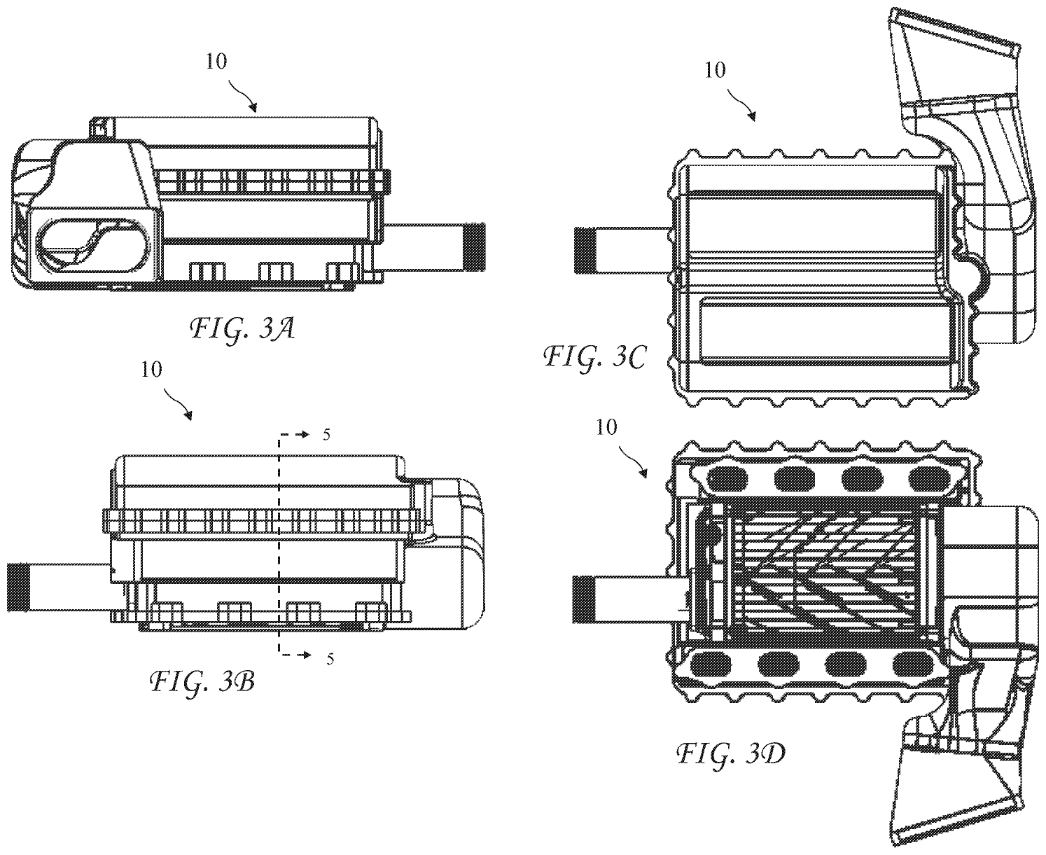

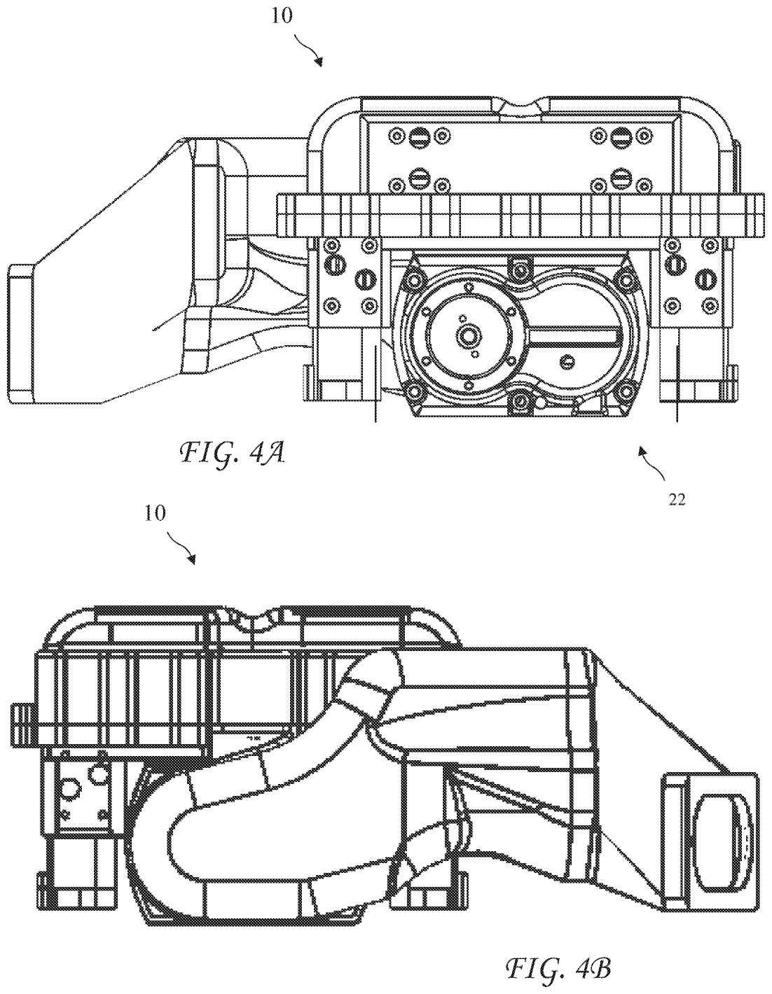

A right side view of the supercharger and intercooler assembly 10 is shown in FIG. 3A, a left side view of the supercharger and intercooler assembly 10 is shown in FIG. 3B, a top view of the supercharger and intercooler assembly 10 is shown in FIG. 3C, a bottom view of the supercharger and intercooler assembly 10 is shown in FIG. 3D, a front view of the supercharger and intercooler assembly 10 is shown in FIG. 4A, and a rear view of the supercharger and intercooler assembly 10 is shown in FIG. 4B.

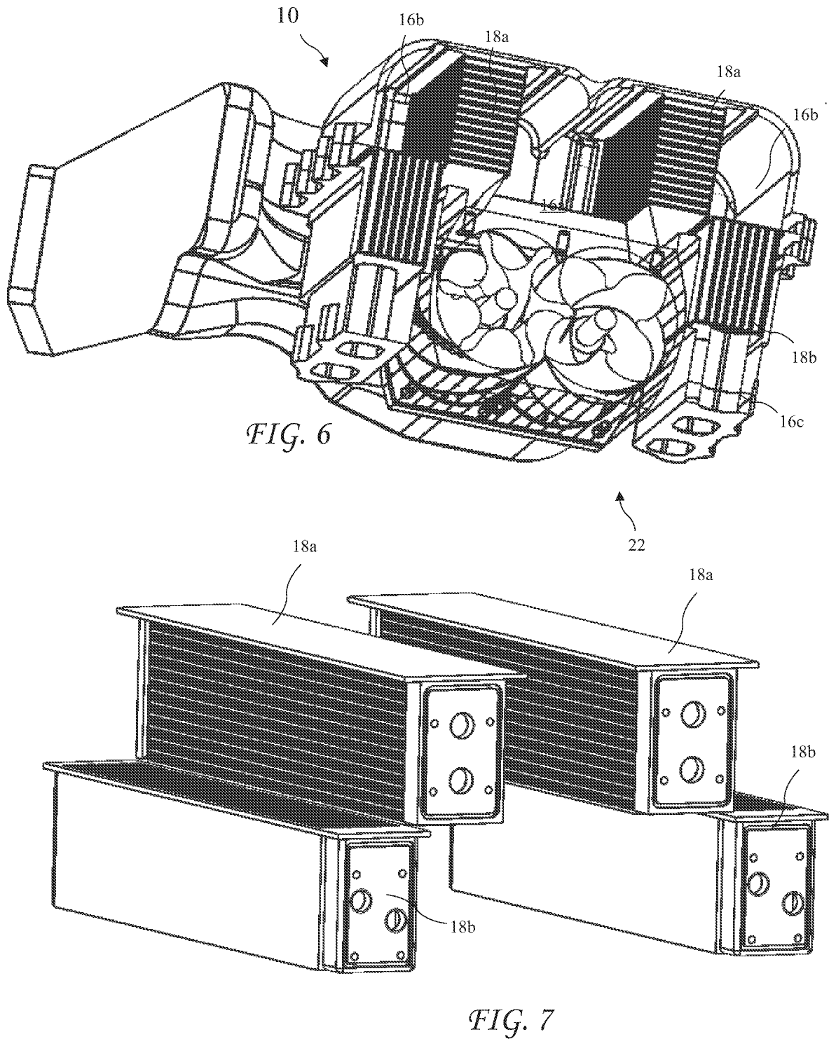

A cross-sectional view of the supercharger and intercooler assembly 10 taken along line 5-5 of FIG. 3B is shown in FIG. 5 and a second cross-sectional view of a supercharger and intercooler assembly 10 taken along line 5-5 of FIG. 3B. is shown in FIG. 6. The supercharger and intercooler assembly 10 includes the supercharger 22 producing an upward and outward supercharger air flow 20a into a first anti-reversion plenum 16a. The upward and outward air flow 20a travels upward against a ceiling 26 of the first anti-reversion plenum 16a and the ceiling 26 and a splitter 30 splits the upward and outward air flow 20a into right and left airflows. There are no restrictions between the supercharger 22 and the ceiling 26 and the splitter 30. The splitter 30 includes a rounded nose 30a facing the supercharger 22.

The upward and outward air flow 20a splits into right and left airflows and enter first right and left heat exchangers 18a and first intercooler airflows 19a pass through the first right and left heat exchangers 18a into two second anti-reversion plenums 16b creating outward and downward second airflows 20b into the second heat exchangers 18b. The outward and downward second airflows 20b create second intercooler airflows 19b through the second heat exchangers 18b. The second intercooler airflows 19b create downward third airflows 20 from the second heat exchangers 18b and into and engine.

The first anti-reversion plenum 16a, first heat exchangers 18a, second anti-reversion plenums 16b, second heat exchangers 18b, and third anti-reversion plenums 16c create right and left air paths inside the intercooler housings 14a and 14b starting above the supercharger 22, splitting to the right and left, and turning down on right and left sides of the supercharger 22. The right and left air paths are preferably continuous air paths having no steps and no recesses to impede air flow. Each anti-reversion plenum starting with the third anti-reversion plenums 16c sequentially reduce reversion, providing increased power, improving fuel economy, better throttle response, driveability, and reducing emissions.

The arrangement of the first and second heat exchangers 18a and 18b is shown in FIG. 7.

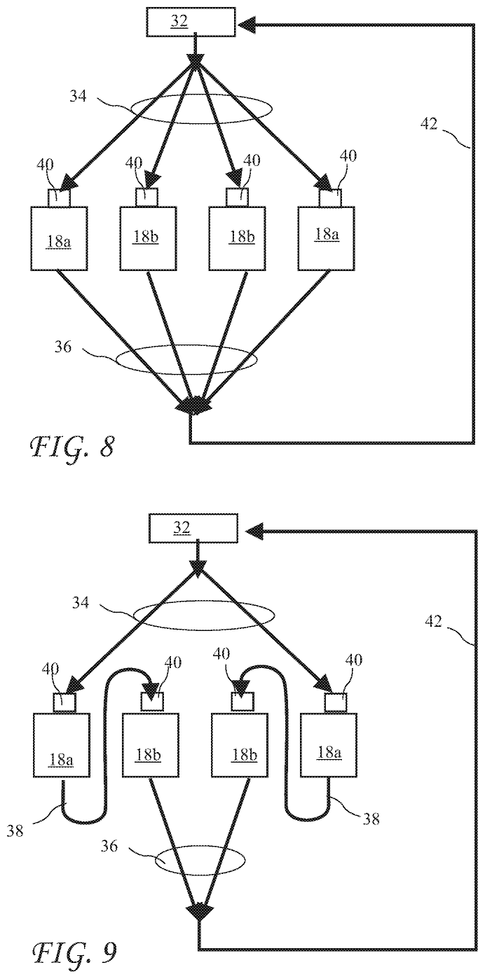

The first and second heat exchangers 18a and 18b having a parallel coolant 42 flows and intercooler assembly 10 are shown in FIG. 8. The heat exchangers 18a and 18b are preferably air to liquid heat exchangers receiving a flow of coolant 42 from a radiator 32 to reduce the temperature of the airflows 20c (see FIG. 5). Valves (or orifices) 40 restrict the flow of coolant 42 to each of the heat exchangers 18a and 18b.

The heat exchangers 18a and 18b are shown connected in series in FIG. 9. The radiator 32 cooled coolant is provided to the heat exchangers 18a and 18b serially through hoses 34 and 38 and returned to a radiator 32 through hoses 36. The valves (or orifices) 40 restrict the flow of coolant 42 to each of the heat exchangers 18a and 18b.

In either parallel or serial arrangement, the coolant 42 flow to each heat exchanger 18a and 18b may be adjusted and directed to tune the effect of each heat exchanger 18a and 18b on the air flows 20c to the right and left engine banks. The use of parallel or series connections may be chosen based on characteristics of individual installations.

While the invention herein disclosed has been described by means of specific embodiments and applications thereof, numerous modifications and variations could be made thereto by those skilled in the art without departing from the scope of the invention set forth in the claims.

I claim:

1. A supercharger and intercooler assembly comprising:
the supercharger;
a supercharger air flow from the supercharger;
an intercooler housing residing above and on right and left sides the supercharger;
right and left air paths inside the intercooler housing starting above the supercharger, splitting to the right and left, and turning down on right and left sides of the supercharger;
a first anti-reversion plenum portion of the right and left air paths directly above the supercharger and in unrestricted fluid communication with the supercharger;
an upward and outward airflow from the supercharger through the first anti-reversion plenum;
two first heat exchangers residing in the right and left air paths on right and left sides of the first anti-reversion plenum;
two second anti-reversion plenums of the right and left air paths on outside right and left sides of the two first heat exchangers in fluid communication with the first anti-reversion plenum through the two first heat exchangers;
right and left outward, downward second airflows through the two second anti-reversion plenums;
two second heat exchangers residing in the right and left air paths below the two second anti-reversion plenums;
two third anti-reversion plenums of the right and left air paths below the two second heat exchangers in fluid communication with the two second anti-reversion plenums through the two second heat exchangers;
downward third air flows through the two third anti-reversion plenums; and
mounting surface below the two third anti-reversion plenums placing the two third anti-reversion plenums in unrestricted fluid communication with intake ports.

2. The supercharger and intercooler assembly of claim 1, wherein the first anti-reversion plenum has a ceiling including a splitter centered directly above the supercharger and in unrestricted fluid communication with the supercharger, the splitter having a downward convex shape with tapered sides directing the supercharger air flow towards the two first heat exchangers on the right and left sides of the first anti-reversion plenum.

3. The supercharger and intercooler assembly of claim 2, wherein the splitter has a rounded nose facing the supercharger.

4. The supercharger and intercooler assembly of claim 1, wherein:
the intercooler housing includes an upper portion above the supercharger and a lower portion on right and left sides of the supercharger; and
the first anti-reversion plenum reaches between a base of the upper portion to a ceiling of the upper portion.

5. The supercharger and intercooler assembly of claim 4, wherein the airflow between the supercharger and first heat exchangers is not restricted by any other heat exchanger.

6. The supercharger and intercooler assembly of claim 5, wherein first intercooler airflows through the first heat exchangers is exclusively horizontal.

7. The supercharger and intercooler assembly of claim 1, wherein the two second anti-reversion plenums have outer, upper curved ceiling portions.

8. The supercharger and intercooler assembly of claim 1, wherein the right and left outward, downward second airflows between first heat exchangers and the second heat exchangers are not restricted by any other heat exchanger.

9. The supercharger and intercooler assembly of claim 9, wherein the second intercooler air flows through the second heat exchangers are vertical.

10. The supercharger and intercooler assembly of claim 1, wherein:
the first and second heat exchangers are air to liquid heat exchangers; and
coolant flows through the first and second heat exchangers are configurable to be sequential or serial.

11. The supercharger and intercooler assembly of claim 1, wherein the right and left air flows are continuous.

12. The supercharger and intercooler assembly of claim 1, wherein the heat exchangers are air to coolant heat exchangers.

13. The supercharger and intercooler assembly of claim 12, wherein the flow of coolant into each heat exchanger it controlled by a valve.

14. The supercharger and intercooler assembly of claim 12, wherein the flow of coolant into each heat exchanger it controlled by an orifice.

15. A supercharger and intercooler assembly comprising:
the supercharger;
a supercharger air flow from the supercharger;
an intercooler housing residing above and on right and left sides the supercharger and defining an upper portion above the supercharger and a lower portion on right and left sides of the supercharger;
right and left air paths inside the intercooler housing starting above the supercharger, splitting to the right and left, and turning down on right and left sides of the supercharger;
a first anti-reversion plenum portion of the right and left air paths directly above the supercharger reaching between a base of the upper portion to a ceiling of the upper portion, and in unrestricted fluid communication with the supercharger;
a ceiling of the first anti-reversion plenum including a splitter centered directly above the supercharger and in unrestricted fluid communication with the supercharger, the splitter having a downward convex shape with tapered sides directing the supercharger air flow towards the two first heat exchangers on the right and left sides of the first anti-reversion plenum;
an unrestricted upward and outward airflow from the supercharger through the first anti-reversion plenum;
two first heat exchangers residing in the right and left air paths on right and left sides of the first anti-reversion plenum;
two horizontal heat exchanger air flows through the two first heat exchangers;
two second anti-reversion plenums of the right and left air paths on outside right and left sides of the two first heat exchangers in fluid communication with the first anti-reversion plenum through the two first heat exchangers;
unrestricted right and left outward, downward second airflows through the two second anti-reversion plenums;
two second heat exchangers residing in the right and left air paths below the two second anti-reversion plenums;
two vertical downward heat exchanger air flows through the two second heat exchangers;
two third anti-reversion plenums of the right and left air paths below the two second heat exchangers in fluid communication with the two second anti-reversion plenums through the two second heat exchangers;
two unrestricted downward third air flows through the two third anti-reversion plenums; and
coolant flows from a radiator to each heat exchanger.

16. A supercharger and intercooler assembly comprising:
the supercharger;
a supercharger air flow from the supercharger;
an intercooler housing residing above and on right and left sides the supercharger and defining an upper portion above the supercharger and a lower portion on right and left sides of the supercharger;
right and left air paths inside the intercooler housing starting above the supercharger, splitting to the right and left, and turning down on right and left sides of the supercharger;
a first anti-reversion plenum portion of the right and left air paths directly above the supercharger reaching between a base of the upper portion to a ceiling of the upper portion, and in unrestricted fluid communication with the supercharger;
a ceiling of the first anti-reversion plenum including a splitter centered directly above the supercharger and in unrestricted fluid communication with the supercharger, the splitter having a downward convex shape with tapered sides directing the supercharger air flow towards the two first heat exchangers on the right and left sides of the first anti-reversion plenum;
an unrestricted upward and outward airflow from the supercharger through the first anti-reversion plenum;
two first heat exchangers residing in the right and left air paths on right and left sides of the first anti-reversion plenum;
two horizontal heat exchanger air flows through the two first heat exchangers;
two second anti-reversion plenums of the right and left air paths on outside right and left sides of the two first heat exchangers in fluid communication with the first anti-reversion plenum through the two first heat exchangers;
unrestricted right and left outward, downward second airflows through the two second anti-reversion plenums;
two second heat exchangers residing in the right and left air paths below the two second anti-reversion plenums;
two downward heat exchanger air flows through the two second heat exchangers;
two third anti-reversion plenums of the right and left air paths below the two second heat exchangers in fluid communication with the two second anti-reversion plenums through the two second heat exchangers;
two unrestricted downward third air flows through the two third anti-reversion plenums;
coolant flows from a radiator to each heat exchanger; and
orifices restricting the flow of the coolant into the heat exchangers.
